(19) United States
(12) Patent Application Publication
(10) Pub. No.: US 2025/0234813 A1
(43) Pub. Date: Jul. 24, 2025

(54) HEDGE TRIMMER AND SYSTEM AND METHOD FOR BLADE ASSEMBLY

(71) Applicant: Milwaukee Electric Tool Corporation, Brookfield, WI (US)

(72) Inventors: Sara M. Manulik, Chicago, IL (US); Alexander G. Steinhauer, Menomonee Falls, WI (US); Brian D. Rothe, Hartland, WI (US); Jacob M. Nolting, Fond du Lac, WI (US)

(21) Appl. No.: 18/985,902

(22) Filed: Dec. 18, 2024

Related U.S. Application Data
(60) Provisional application No. 63/615,446, filed on Dec. 28, 2023.

(51) Int. Cl. A01G 3/053

(52) U.S. Cl. CPC A01G 3/053

(57) ABSTRACT

A hedge trimmer and a tool assembly for assembling a blade assembly are provided. The hedge trimmer includes a housing at which a motor is disposed. The blade assembly extends from the housing and includes a blade component forming a blade opening through which a fastener is extendable. A retainer forms a retainer opening through which the fastener is extendable. A second spine opening at a spine extends from a first spine opening at the spine. The second spine opening forms a narrower cross section relative to the first spine opening. The fastener is extendable into the second spine opening from the first spine opening. The retainer is positioned between the spine and the blade component.

### PRIORITY STATEMENT

The present disclosure claims the benefit of priority to U.S. provisional application No. 63/615,446, filed Dec. 28, 2023, the disclosure of which is incorporated by reference herein in its entirety.

### FIELD

The present disclosure relates generally to lawn and garden tools, and more particularly, to a hedge trimmer and a system and method for blade assembly.

### BACKGROUND

Hedge trimmers may generally include a blade joined to a spine using a plurality of fasteners. Methods and tools for joining the blade to the spine may require a plurality of tools to hold and/or turn the fasteners to join the blade to the spine. Such methods and tools may further require access by a user to multiple sides of the blade and spine, such as top and bottom sides that may correspond to a head and nut of the fasteners.

Such hedge trimmers, and methods and systems for blade assembly, may increase cost and complexity of assembly. Improved hedge trimmers, and methods and systems for blade assembly, are desired in the art. Furthermore, hedge trimmers, and methods and systems for blade assembly, that address one or more of these issues would be beneficial and advantageous.

### BRIEF DESCRIPTION

Aspects and advantages of the invention in accordance with the present disclosure will be set forth in part in the following description, or may be obvious from the description, or may be learned through practice of the technology.

An aspect of the present disclosure is directed to a hedge trimmer including a housing at which a motor is disposed. A blade assembly extends from the housing. The blade assembly includes a blade component forming a blade opening through which a fastener is extendable. A retainer forms a retainer opening through which the fastener is extendable. A spine forms a first spine opening and a second spine opening. The second spine opening extends from the first spine opening. The second spine opening forms a narrower cross section relative to the first spine opening. The fastener is extendable into the second spine opening from the first spine opening. The retainer is positioned between the spine and the blade component.

An aspect of the present disclosure is directed to a method for assembling a hedge trimmer blade assembly. The method includes disposing a fastener into a fastener opening at a base fixture; disposing a blade component onto the base fixture, wherein a blade component opening is positioned over the fastener to extend a neck of the fastener through the blade component opening; disposing a retainer onto the blade component, wherein a retainer opening is positioned over the fastener to extend the neck of the fastener through the retainer opening; disposing a spine onto the retainer, wherein a first spine opening is positioned over the fastener such that the neck of the fastener is positioned through the blade component opening, the retainer opening, and the first spine opening; and forcing the spine toward a second spine opening extending from the first spine opening, wherein forcing the spine toward the second spine opening positions the neck of the fastener through the blade component opening, the retainer opening, and the second spine opening.

An aspect of the present disclosure is directed to a blade assembly for a lawn and garden tool. The blade assembly includes a blade component forming a blade opening through which a fastener is extendable. A retainer forms a retainer opening through which the fastener is extendable. A spine forms a first spine opening and a second spine opening. The second spine opening extends from the first spine opening. The second spine opening forms a narrower cross section relative to the first spine opening. The fastener is extendable into the second spine opening from the first spine opening. The retainer is positioned between the spine and the blade component.

An aspect of the present disclosure is directed to a tool assembly for assembling a blade assembly. The tool assembly includes a base forming a channel extending co-directional to a blade component of the blade assembly. A fastener opening is formed in the channel. The fastener opening includes a floor configured to receive a fastener of the blade assembly. The floor is positioned in the fastener opening to allow a neck of the fastener to extend through the fastener opening. A depth of the fastener opening corresponds to an extension along a heigh of a base wall of the fastener. A press fixture is configured to position over the blade component at the channel of the base. The press fixture is configured to engage a spine of the blade assembly to translate the fastener along a direction of the blade component.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIG. 1 depicts a perspective view of an exemplary embodiment of a hedge trimmer assembly including a blade assembly, in accordance with aspects of the present disclosure;

FIG. 2 depicts an exploded view of an embodiment of a blade assembly in accordance with aspects of the present disclosure;

FIG. 2 depicts an exploded view of an embodiment of a blade assembly in accordance with aspects of the present disclosure;

FIG. 3 depicts an exploded view of the blade assembly of FIG. 2 in accordance with aspects of the present disclosure;

FIG. 4 depicts a perspective view of the blade assembly of FIG. 3 in a first position, in accordance with aspects of the present disclosure;

FIG. 5 depicts a perspective view of the blade assembly of FIG. 3 in a second position, in accordance with aspects of the present disclosure;

FIG. 6A depicts a perspective view of an embodiment of a fastener for a blade assembly in accordance with aspects of the present disclosure;

FIG. 6B depicts a longitudinal side view of the fastener of FIG. 6A in accordance with aspects of the present disclosure;

FIG. 6C depicts a width side view of the fastener of FIG. 6A in accordance with aspects of the present disclosure;

FIG. 7A depicts a perspective view of an embodiment of a retainer of the blade assembly in accordance with aspects of the present disclosure;

FIG. 7B depicts a detail view of a portion of the retainer of FIG. 7A in accordance with aspects of the present disclosure;

FIG. 8A depicts a perspective view of an embodiment of a spine of the blade assembly in accordance with aspects of the present disclosure;

FIG. 8B depicts a detail view of a portion of the spine of FIG. 8A in accordance with aspects of the present disclosure;

FIG. 9 depicts a top-down view of an embodiment of the spine of the blade assembly in accordance with aspects of the present disclosure;

FIG. 10 depicts a top-down view of an embodiment of a blunt body member of an embodiment of a hedge trimmer assembly in accordance with aspects of the present disclosure;

FIG. 11 depicts a cross-sectional view of an embodiment of a portion of a blade assembly in accordance with aspects of the present disclosure;

FIG. 12 depicts a perspective view of an embodiment of a tooling system and an embodiment of a blade assembly in accordance with aspects of the present disclosure;

FIG. 12 depicts a perspective view of an embodiment of a tooling system and an embodiment of steps of a method for assembling a blade assembly in accordance with aspects of the present disclosure;

FIG. 13 depicts a perspective view of the tooling system and an embodiment of steps of the method for assembling the blade assembly in accordance with aspects of the present disclosure;

FIG. 14 depicts a perspective view of the tooling system and an embodiment of steps of the method for assembling the blade assembly in accordance with aspects of the present disclosure;

FIG. 15 depicts a perspective view of the tooling system and an embodiment of steps of the method for assembling the blade assembly in accordance with aspects of the present disclosure;

FIG. 16 depicts a perspective view of the tooling system and an embodiment of steps of the method for assembling the blade assembly in accordance with aspects of the present disclosure;

FIG. 17 depicts a perspective view of the tooling system and an embodiment of steps of the method for assembling the blade assembly in accordance with aspects of the present disclosure; and

FIG. 18 depicts a flowchart outlining steps of a method for assembling a blade assembly in accordance with aspects of the present disclosure.

Repeat use of reference characters in the present specification and drawings is intended to represent the same or analogous features or elements of the present invention.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

Embodiments of a hedge trimmer assembly 100, a blade assembly 110, a fastener 120, a tooling system 200 for blade assembly, and a method for blade assembly (hereinafter, “method 1000”) are provided. Embodiments of the hedge trimmer assembly 100, the blade assembly 110, and the fastener 120 provided herein may include and facilitate fewer parts, such as fewer fasteners, at the blade assembly for hedge trimmers than known hedge trimmers and blade assemblies. Embodiments of the tooling system 200 and method 1000 for blade assembly provided herein may facilitate inclusion of fewer fasteners at a lawn and garden tool, such as a hedge trimmer assembly. Embodiments provided herein may reduce a quantity of parts; facilitate assembly from a single side of the blade without requiring access to a second side (e.g., a back side); obviate a need for torque tools, reduce weight of the hedge trimmer assembly, blade assembly, and tooling; mitigate errors during assembly (e.g., errors associated with fastener placement or torquing); increase service life of the hedge trimmer assembly and blade assembly; or facilitate aesthetic improvement of the blade assembly and hedge trimmer assembly.

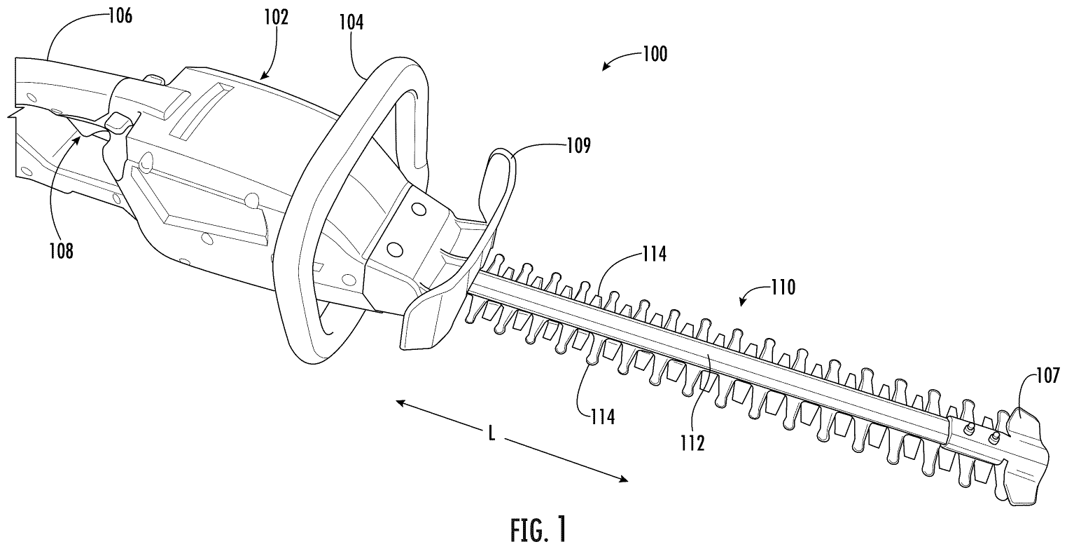

Referring now to the drawings, FIG. 1 depicts an exemplary embodiment of a lawn and garden tool forming a hedge trimmer assembly 100 in accordance with aspects of the present disclosure. The hedge trimmer assembly 100 includes a housing 102 at which a motor and power accessories (not depicted) are positioned to operate a blade assembly 110. User interfaces 104, 106, such as handle(s), are positioned and configured to facilitate a user to grab, operate, and articulate the hedge trimmer assembly 100, such as may generally be understood in the art. A power articulation interface 108, such as a button or trigger, is positioned at the housing 102 and/or one or more of the user interfaces 104, 106, and configured to allow the user to selectively provide energy to operate the blade assembly 110. A wall 109 may be positioned between the housing 102 and the blade assembly 110, such as to form a guard that may form a barrier between the user (or a portion of the user, such as the user's hands) and the blade assembly 110, as may generally be understood in the art.

The blade assembly 110 is attached to the housing 102 and extends from the housing 102, such as along a longitudinal direction L. The blade assembly 110 may generally include one or more blade components 114 such as may form a first and second blade, or an articulating member and a stationary member, or a pair of articulating members. A member 112 extends from the housing 102 and may generally form a structural or rigid blunt body extension along which the blade component(s) 114 are supported, such along the longitudinal direction L. An end guard 107 may be positioned at a distal end of the blade assembly 110. The end guard 107 may at least partially obscure a portion of the blade assembly 110 distal to the housing 102, such as to provide a barrier between blade component(s) 114 and objects, items, etc. beyond the hedge trimmer assembly 100.

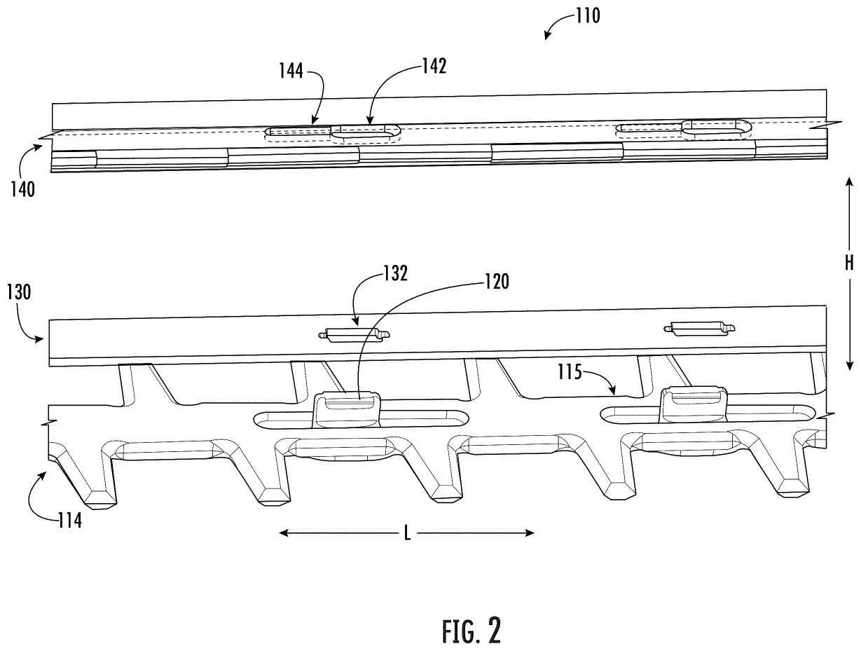

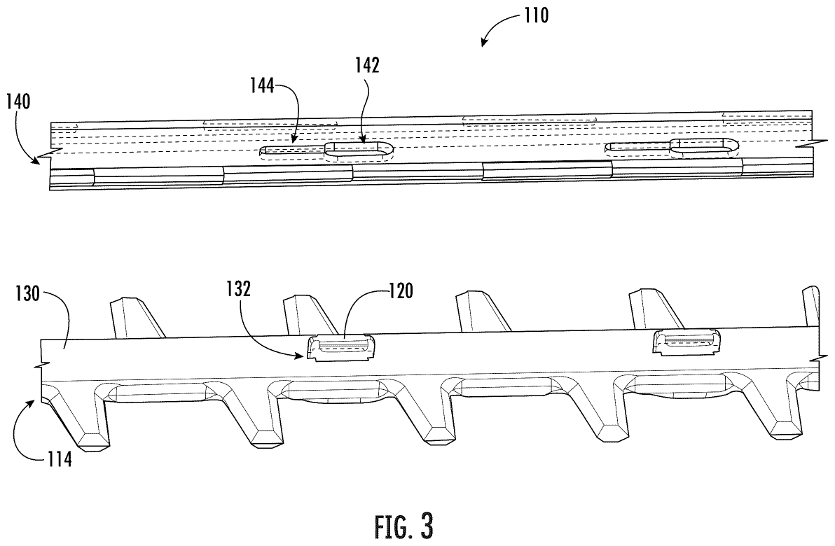

Referring now to FIGS. 2-17, embodiments of components, tools, and methods for assembly in accordance with aspects of the present disclosure are provided. FIGS. 2-5 provide exploded perspective views of portions of an embodiment of the blade assembly 110 and generally depict steps for assembly of the blade assembly 110 in accordance with embodiments of the method 1000 further described herein. The blade assembly 110 includes one or more blade components 114, such as including a plurality of teeth or cutting members distributed along the longitudinal direction L. The blade component 114 forms a slot or opening 115 through which a fastener 120 is extendable. A retainer 130 forming a wall includes a retainer opening 132 through which the fastener 120 is extendable. The retainer 130 is positioned onto the blade component 114 between the blade component 114 and a spine 140. The spine 140 forms a wall including a first spine opening 142 and a second spine opening 144 extending from the opening 142. The second opening 144 forms a narrower cross-sectional opening relative to the first opening 142, such as a narrower cross-sectional opening along a width direction W perpendicular to the longitudinal direction L.

In various embodiments, one or more of the openings 115, 132, 142 extend co-directional to an extension of the blade component 114, such as along longitudinal direction L. In still various embodiments, the retainer 130 and the spine 140 is stackable (e.g., along height H) onto the blade component 114, such as further described herein.

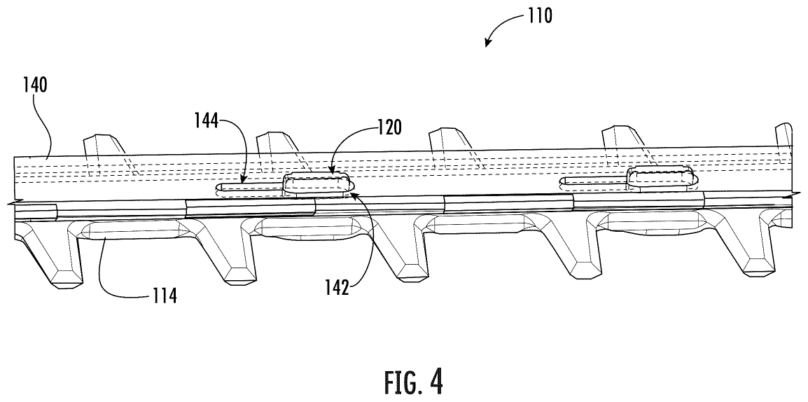

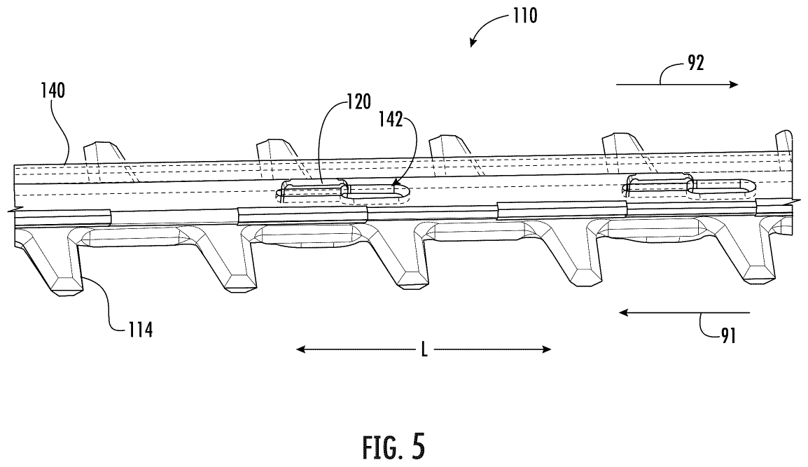

Referring to FIGS. 4-5, the fastener 120 extends through first spine opening 142, such as during stacking of the spine 140 onto the retainer 130. The openings 142, 144 are positioned to allow a user to articulate the blade component 114 along a first direction (e.g., first direction 91 along the longitudinal direction L), or articulate the spine 140 along a second direction (e.g., second direction 92 opposite of the first direction 91 along longitudinal direction L), or both, to position an extension of the fastener 120 through the spine 140 from the first opening 142 (depicted in FIG. 4 in a first position) into the second opening 144 (depicted in FIG. 5 in a second position). The narrower cross-sectional area at opening 144 may form a press-fit, interference-fit, or other type of friction fit to retain the blade component 114, retainer 130, and spine 140 together via fastener 120.

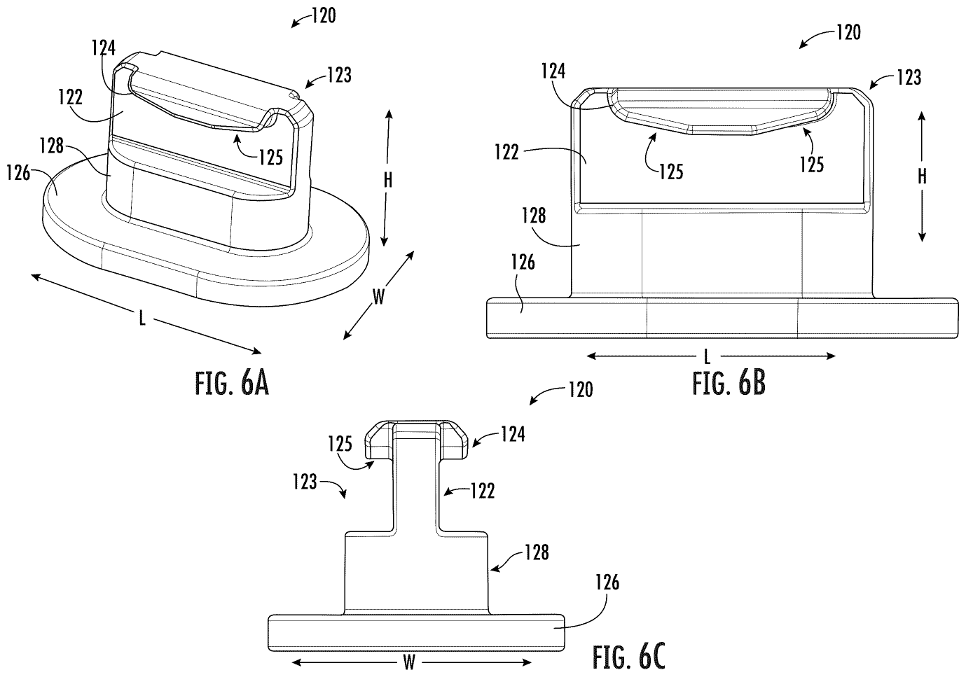

Referring now to FIGS. 6A-6C, views of an embodiment of the fastener 120 are provided. Embodiments of the fastener 120 include a base wall 126 from which a tab 123 extends along the height direction H perpendicular to the longitudinal direction L and width direction W. The tab 123 includes a base portion 128 connected to the base wall 126. A neck 122 extends from the base portion 128. A wing 124 extends from the neck 122.

In various embodiments, the neck 122 forms a narrower cross section along the width direction W than the base portion 128. The wing 124 extends from the neck 122 along the width direction W. In some embodiments, the wing 124 extends along the width direction W greater than the neck 122.

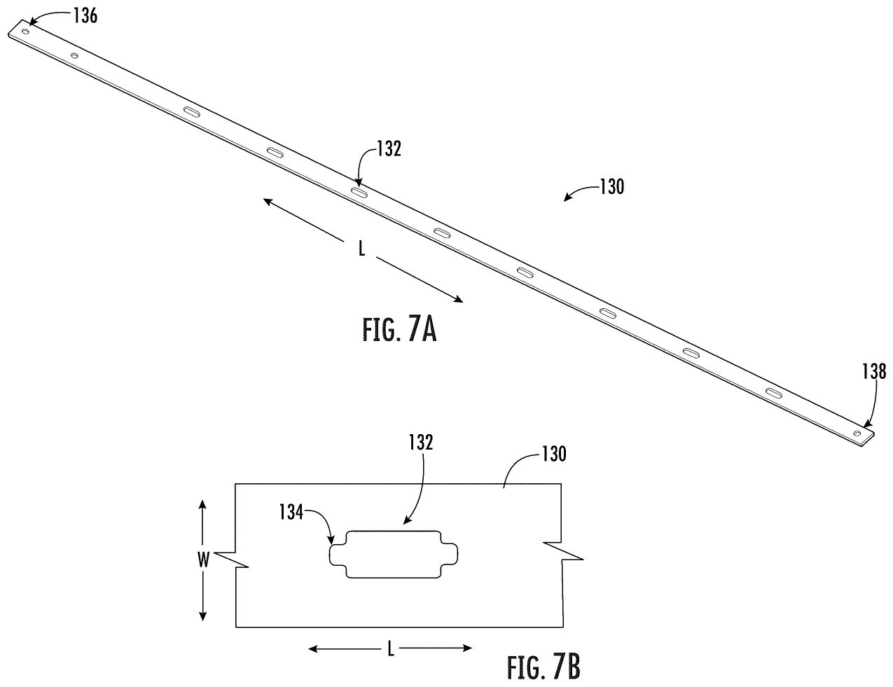

In still some embodiments, the base portion 128 may extend along the height direction H corresponding to a thickness along the height direction H of the retainer 130 and the height of the opening 115. Referring briefly to the perspective and detailed views of an embodiment of the retainer 130 in FIGS. 7A-7B, the retainer opening 132 may include a notch 134 extending along the longitudinal direction L from a central portion forming the retainer opening 132. The notch 134 may correspond in cross sectional area to the neck 122 at the fastener 120. In still some embodiments, the notch 134 extends along the first direction 91, the second direction 92, or both, from the retainer opening 132. During assembly, such as described herein and generally depicted in FIGS. 2-5, a portion of the fastener 120, such as the neck 122, may be extended into the notch 134, such as may facilitate retention, orientation, or keying of components of the blade assembly 114 to one another.

Referring to FIGS. 7A-7B, in various embodiments, the retainer 130 may form wall at which a plurality of retainer openings 132 is positioned corresponding to a plurality of fasteners 120. The retainer 130 may form a wall extending along the longitudinal direction L at which the plurality of retainer openings 132 is distributed along the longitudinal direction L. In still some embodiments, the retainer 130 forms a unitary, monolithic component, such as bar, sheet, or stamping.

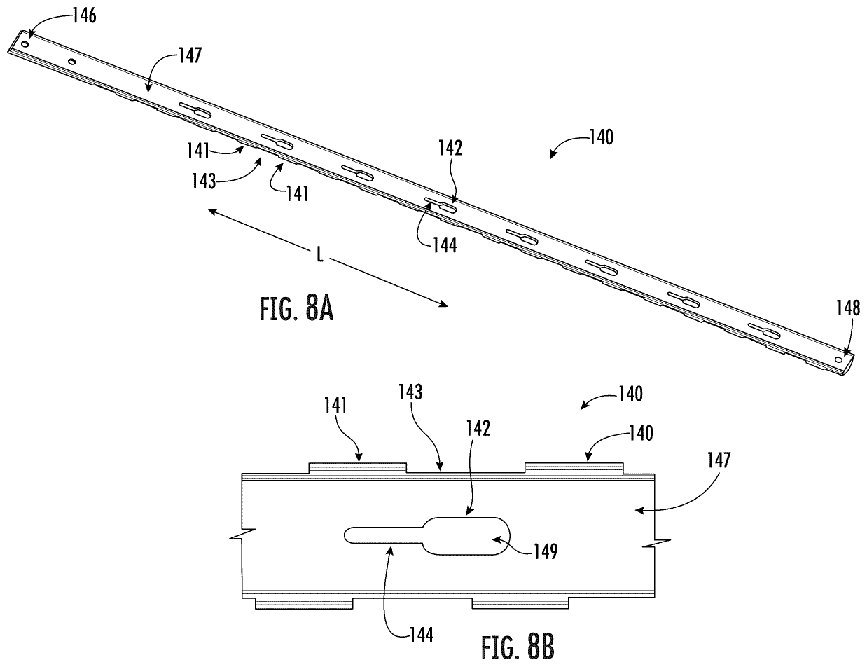

Referring to FIGS. 8A8B, a perspective view and a detailed view of an embodiment of the spine 140 is provided. In various embodiments, the spine 140 may form a wall at which a plurality of spine openings 142, 144 is positioned corresponding to the plurality of fasteners 120. The spine 140 may form a wall extending along the longitudinal direction L at which the plurality of spine openings 142, 144 is distributed along the longitudinal direction L. The second spine opening 144 extends along the longitudinal direction L from the first spine opening 142. For instance, the second spine opening 144 may extend along the longitudinal direction L along the first direction 91, the second direction 92, or both, from a respective first spine opening 142.

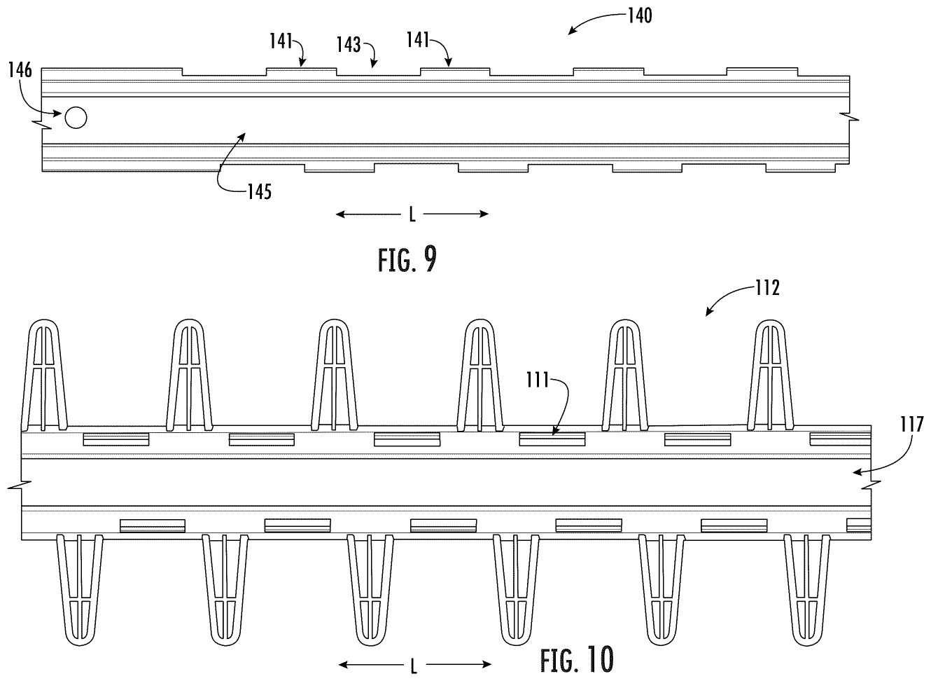

Referring still to FIGS. 8A-8B, and furthermore to FIG. 9, in some embodiments, the spine 140 includes a first face 147 through which spine openings 142, 144 are formed therethrough, such as to allow at least a portion of the fastener 120 to extend along the height direction H through the first face 147. For instance, the first spine opening 142 is formed through the first face 147 to allow the neck 122 to extend through the opening 142. The second spine opening 144 is formed through the first face 147 and extending from the first spine opening 142. The narrower cross sectional width of the second spine opening 144 may retain the neck 122 of the fastener 120 to the spine 140. In some embodiments, the wing 124 (FIGS. 6A-6C) of the fastener 120 is configured to extend along the width direction W to prevent removal of the fastener 120 through the second spine opening 144. In still some embodiments, the wing 124 extends greater along the width direction W than the second spine opening 144, or furthermore, the notch 134, such as to retain the spine 140 to the retainer 130 and blade component 114.

In still yet some embodiments, a ramp 125 (FIGS. 6A-6C) extends from the wing 124 along the height direction H toward the base wall 126. The ramp 125 is configured to promote friction-fit, such as press-fit or interference-fit, of the fastener 120 to the spine 140 when the fastener 120 is articulated into the second spine opening 144. For instance, the ramp 125 may extend along the height direction H to rub, touch, or contact the first face 147 of the spine 140.

Referring still to FIGS. 8A-8B, and furthermore to FIG. 9, in some embodiments, the spine 140 includes the first face 147, a second face 145, and a plenum 149 formed therebetween. The second face 145 may obscure a top portion of the fastener 120, such as the wing 124. The wing 124 of the fastener 120 may be positioned within the plenum 149 between the first and second faces 145, 147.

Referring now to FIGS. 9-10, embodiments of the spine 140 and the member 112 are provided. In some embodiments, the member 112 includes a bar or plate 117 extending co-directional to the blade component 114. A member opening 111 may be formed corresponding to a rib 141 extending from the spine 140. A plurality of ribs 141 may be distributed along the longitudinal direction L. A space or recess 143 may be formed between pairs of ribs 141. A plurality of member openings 111 may be formed at the member 112 corresponding to the plurality of ribs 141. When assembled, ribs 141 may extend into openings 111 and hook or latch onto the member 112. Ribs 141 may form a retention feature to at least partially connect the spine 140 onto the member 112.

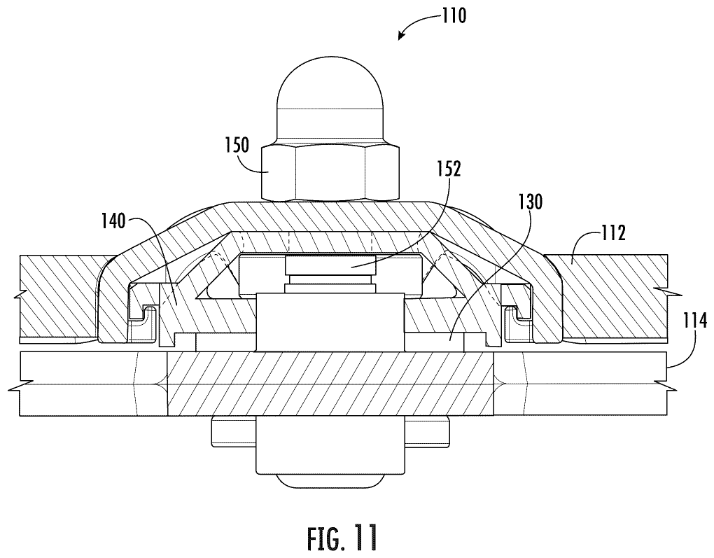

Referring briefly back to FIGS. 7A and 8A, and further viewing the cross-sectional side view at FIG. 11, retainer 130 and spine 140 may form openings 136, 138, 146, 148 at which the retainer 130 and spine 140 may couple to the housing 102 (FIG. 1) of the hedge trimmer assembly 100. Openings 136, 146 may form proximal end openings at which the retainer 130 and spine 140 connect to the housing 102 (FIG. 1). Openings 138, 148 may form distal end openings at which the end guard 107 is attachable. In various embodiments, member 112, blade component 114, or both, may include opening(s) corresponding to openings 136, 146 or openings 138, 148, at which the blade assembly 110 is attachable to the member 112.

Referring to FIG. 11, in some embodiments, a fastener 150 may extend through the member 112, the spine 140, the retainer 130, and the blade component 114. For instance, a threaded shank 152 may extend through openings at the member 112, the spine 140, the retainer 130, the blade component 114, or combinations thereof, such as to attach the blade assembly 110 to the member 112.

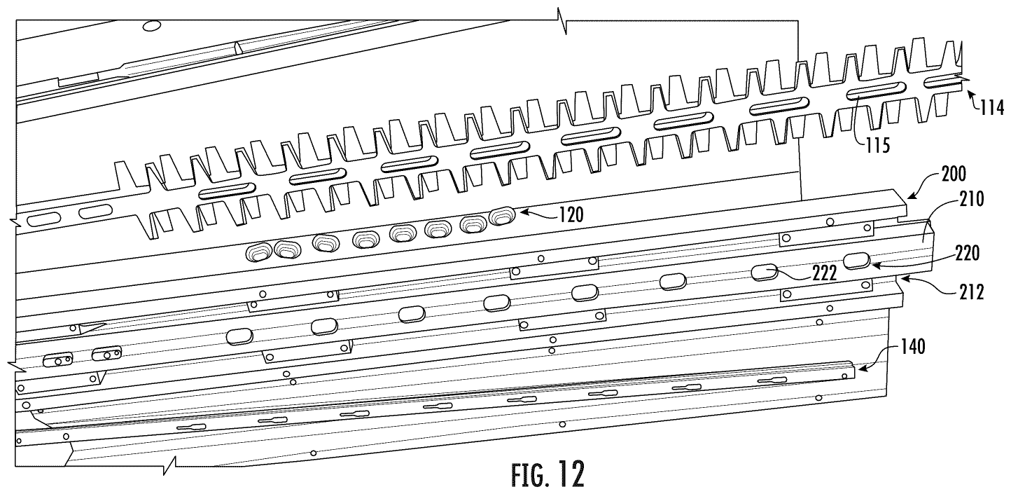

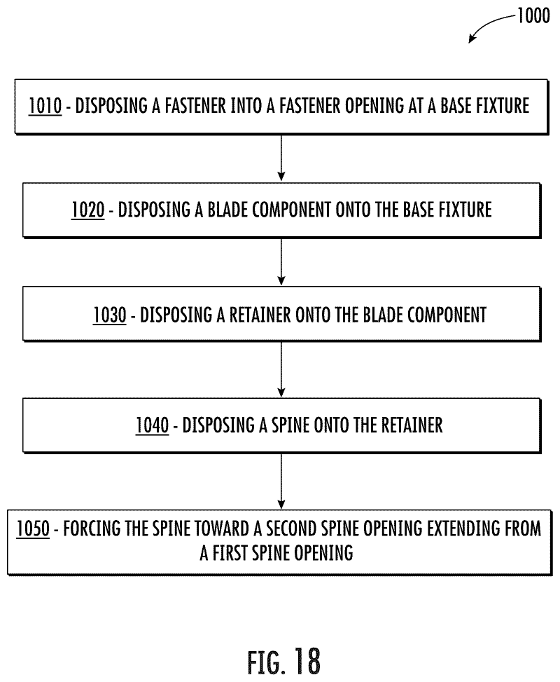

Referring now to FIGS. 12-17, views depicting an exemplary embodiment a tooling system 200 for blade assembly are provided. Referring to FIG. 18, a flowchart outlining exemplary steps of the method 1000 is provided. Referring to FIGS. 12-17, the tooling system 200 includes a base 210 forming a channel 212 into which a blade component (e.g., blade component 114) is disposable. In various embodiments, the base 210 forms the channel 212 extending co-directional to the blade component 114, such as along the longitudinal direction L. The base 210 forms a fastener opening or recess 220 into which embodiments of the fastener 120 such as depicted and described herein are disposable. The base 210 forms a floor 222 at which the fastener 120 is disposable to extend through the recess 220. For instance, fastener 120 is disposed through the recess 220 and base wall 126 of the fastener 120 is positioned onto the floor 222 to allow the neck 122 to extend through the recess 220. In some embodiments, a depth or height of the recess 220 corresponds to an extension along height direction H of the base wall 126. For instance, when inserted into the recess 220, neck 122 extends from above the recess 220.

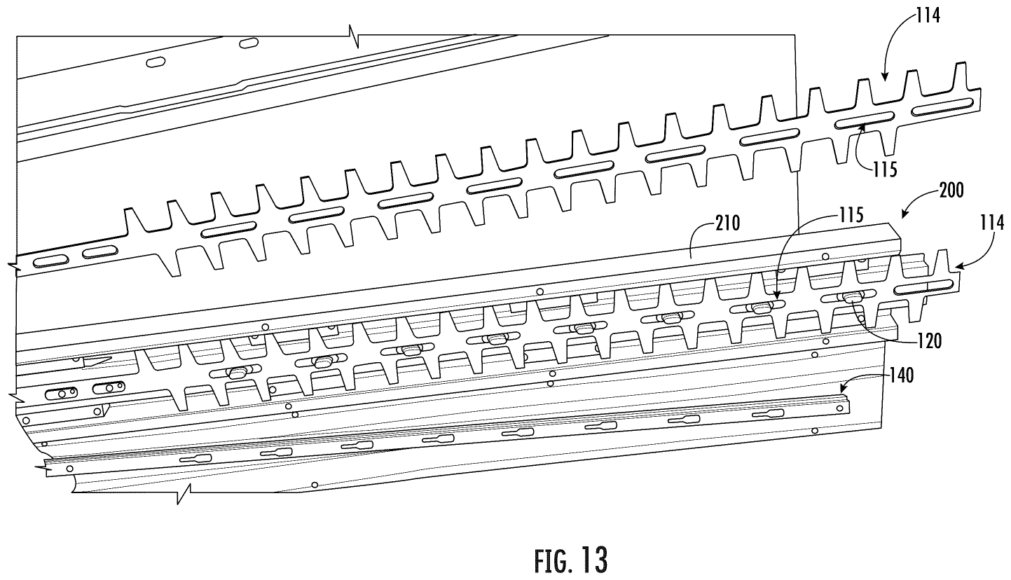

Referring to FIG. 18, method 1000 includes at 1010 positioning, disposing, or otherwise inserting a fastener (e.g., fastener 120) into a fastener opening or recess (e.g., recess 220) at a base fixture (e.g., base 210), such as depicted in FIG. 13. In various embodiments, method 1000 at 1010 includes inserting a plurality of fasteners into respective fastener recesses at the base. In some embodiments, method 1000 at 1010 includes disposing the plurality of fasteners in adjacent arrangement along a direction corresponding to an extension of a second spine opening (e.g., second spine opening 144) from a first spine opening (e.g., first spine opening 142). For instance, the second spine opening 144 extends from the first spine opening 142 along the longitudinal direction L, and the plurality of fasteners 120 is disposed into recess(es) 220 at the base 210 in adjacent arrangement along the longitudinal direction L.

Method 1000 includes at 1020 disposing one or more blade components (e.g., blade component 114) onto the base fixture, such as depicted in FIG. 13. In various embodiments, method 1000 at 1020 includes disposing a blade component opening (e.g., opening 115) over the fastener (e.g., fastener 120), such that the neck of the fastener extends through the blade component opening. In still some embodiments, method 1000 at 1020 includes disposing respective blade component openings over respective fasteners.

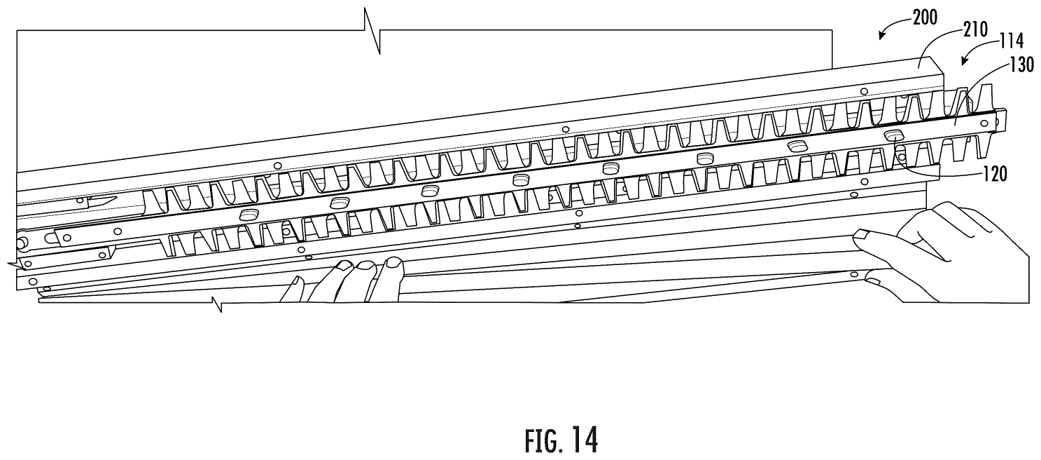

Method 1000 includes at 1030 disposing a retainer (e.g., retainer 130) onto the blade component (e.g., blade component 114), such as depicted in FIG. 14. In various embodiments, method 1000 at 1030 includes disposing a retainer opening (e.g., opening 132) over the fastener (e.g., fastener 120), such that the neck of the fastener extends through the blade component opening and the retainer opening. In still some embodiments, method 1000 at 1030 includes disposing respective retainer openings over respective fasteners extending through respective blade component openings.

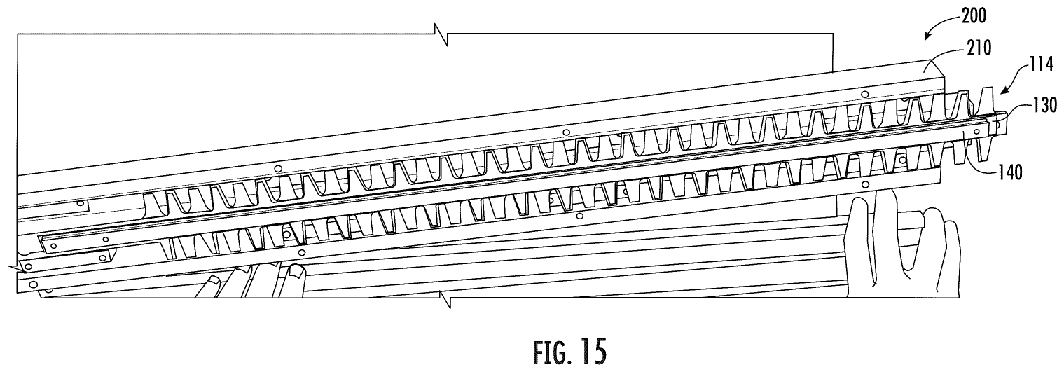

Method 1000 includes at 1040 disposing a spine (e.g., spine 140) onto the retainer (e.g., retainer 130), such as depicted in FIG. 15. In various embodiments, method 1000 at 1040 includes disposing a first spine opening (e.g., first spine opening 142) over the fastener (e.g., fastener 120), such that the neck of the fastener extends through the blade component opening, the retainer opening, and the first spine opening. In still some embodiments, method 1000 at 1040 includes disposing respective first spine openings over respective retainer openings and blade component openings.

Method 1000 includes at 1050 forcing or pressing the spine toward a second spine opening (e.g., second spine opening 144) extending from the first spine opening. In various embodiments, the second spine opening 144 is positioned adjacent along the longitudinal direction L to the first spine opening 142. Pressing the spine 140 toward the second spine opening 144 may include pressing or friction-fitting the spine 140 along the longitudinal direction L, such as to press-fit, interference-fit, or other friction-fit the neck 122 into the second spine opening 144 to secure the fastener 120, the retainer 130, the spine 140, and the blade component 114 together. Pressing the spine toward the second spine opening positions the neck of the fastener through the second spine opening, the blade component opening, and the retainer opening.

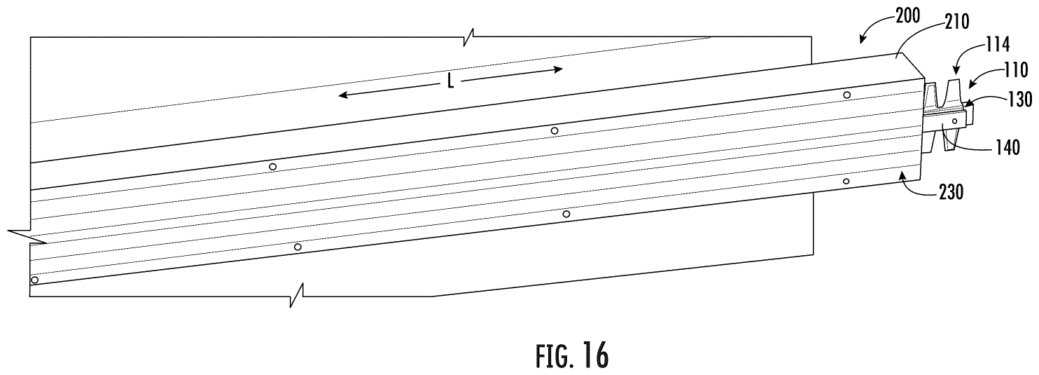

Referring to FIG. 16, in some embodiments, the tooling assembly 200 includes a press fixture 230 configured to position over the blade component 114, the retainer 130, the spine 140, and the retainer 120. The press fixture 230 is configured to engage the spine 140 to engage and push the second spine opening 144 over the neck 122 of the fastener 120.

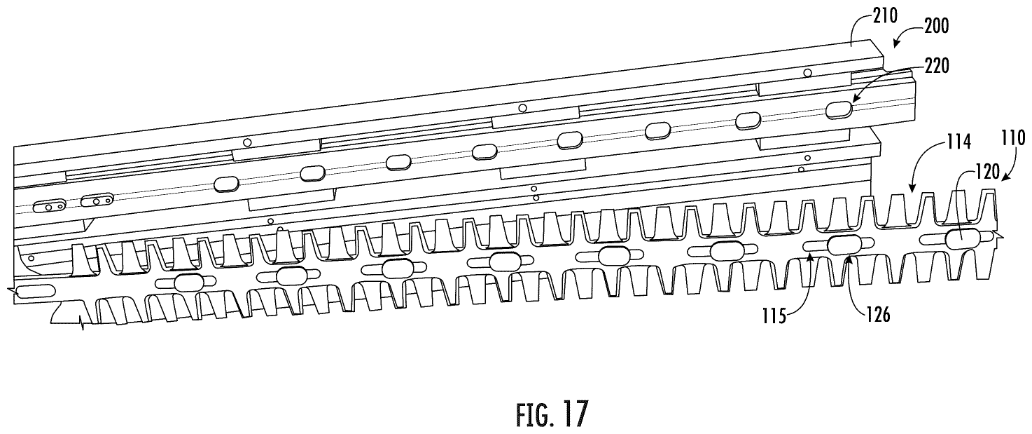

Referring now to FIG. 17, a bottom view of the blade assembly 110 removed from the tooling assembly 200 is depicted. FIG. 17 depicts the base wall 126 positioned adjacent a bottom side of the blade component 114 and blade assembly 110. For instance, FIG. 17 depicts an exemplary embodiment of the base wall 126 of the fastener 120 removed from the recess 220 at the base 210.

Embodiments of the hedge trimmer assembly 100, the blade assembly 110, the fastener 120, the tooling system 200 for blade assembly, and the method for blade assembly 1000 provided herein may include and facilitate fewer parts, such as fewer fasteners, at the blade assembly for hedge trimmers than known hedge trimmers and blade assemblies. Embodiments of the tooling system 200 and method 1000 for blade assembly provided herein may facilitate inclusion of fewer fasteners at a lawn and garden tool, such as a hedge trimmer assembly. Embodiments provided herein may reduce a quantity of parts; facilitate assembly from a single side of the blade without requiring access to a second side (e.g., a back side); obviate a need for torque tools, reduce weight of the hedge trimmer assembly, blade assembly, and tooling; mitigate errors during assembly (e.g., errors associated with fastener placement or torquing); increase service life of the hedge trimmer assembly and blade assembly; or facilitate aesthetic improvement of the blade assembly and hedge trimmer assembly.

Further aspects and embodiments of the present subject matter are provided in the following clauses:

1. A hedge trimmer, including a housing configured at which a motor is disposed; a blade assembly extending from the housing, the blade assembly including; a blade component forming a blade opening through which a fastener is extendable; a retainer forming a retainer opening through which the fastener is extendable; a spine forming a first spine opening and a second spine opening, wherein the second spine opening extends from the first spine opening, and wherein the second spine opening forms a narrower cross section relative to the first spine opening, wherein the fastener is extendable into the second spine opening from the first spine opening, and wherein the retainer is positioned between the spine and the blade component.

2. The hedge trimmer of any one or more clauses herein, wherein the fastener is friction-fit into the second spine opening.

3. The hedge trimmer of any one or more clauses herein, the fastener including a base wall; a tab extending from the base wall, wherein the tab includes a base portion connected to the base wall, and wherein the tab includes a neck extending from the base portion, the neck forming a narrower cross section relative to the base portion and corresponding to the second spine opening.

4. The hedge trimmer of any one or more clauses herein, the fastener including a wing extending from the neck, the wing forming a cross section greater than the neck.

5. The hedge trimmer of any one or more clauses herein, wherein the wing includes a ramp extending from the wing toward the base wall, wherein the ramp is configured to friction-fit the fastener to the spine when the fastener is positioned in the second spine opening.

6. The hedge trimmer of any one or more clauses herein, wherein the blade opening and retainer opening each extend co-directional to an extension of second spine opening from the first spine opening.

7. The hedge trimmer of any one or more clauses herein, the spine including a first face at which the first spine opening and the second spine opening are formed; and a second face extending over the fastener extended into the first spine opening or second spine opening, wherein the first face and the second face form a plenum therebetween at which at least a portion of the fastener extended through the first spine opening or second spine opening is positioned.

8. The hedge trimmer of any one or more clauses herein, including a second fastener extendable through respective openings at the spine, the retainer, the blade component, and a blunt body member.

9. A method for assembling a hedge trimmer blade assembly, including disposing a fastener into a fastener opening at a base fixture; disposing a blade component onto the base fixture, wherein a blade component opening is positioned over the fastener to extend a neck of the fastener through the blade component opening; disposing a retainer onto the blade component, wherein a retainer opening is positioned over the fastener to extend the neck of the fastener through the retainer opening; disposing a spine onto the retainer, wherein a first spine opening is positioned over the fastener such that the neck of the fastener is positioned through the blade component opening, the retainer opening, and the first spine opening; and forcing the spine toward a second spine opening extending from the first spine opening, wherein forcing the spine toward the second spine opening positions the neck of the fastener through the blade component opening, the retainer opening, and the second spine opening.

10. The method of any one or more clauses herein, wherein forcing the spine toward the second spine opening includes friction-fitting the neck of the fastener into the second spine opening.

11. The method of any one or more clauses herein, wherein forcing the spine toward the second spine opening includes friction-fitting a ramp of the neck of the fastener onto the spine.

12. The method of any one or more clauses herein, wherein forcing the spine toward the second spine opening includes translating the neck of the fastener from the first spine opening to the second spine opening, wherein the second spine opening corresponds in cross section to the neck of the fastener.

13. A blade assembly for a lawn and garden tool, the blade assembly including a blade component forming a blade opening through which a fastener is extendable; a retainer forming a retainer opening through which the fastener is extendable; a spine forming a first spine opening and a second spine opening, wherein the second spine opening extends from the first spine opening, and wherein the second spine opening forms a narrower cross section relative to the first spine opening, wherein the fastener is extendable into the second spine opening from the first spine opening, and wherein the retainer is positioned between the spine and the blade component.

14. The blade assembly of any one or more clauses herein, wherein the fastener is friction-fit into the second spine opening.

15. The blade assembly of any one or more clauses herein, the fastener including a base wall; a tab extending from the base wall, wherein the tab includes a base portion connected to the base wall, and wherein the tab includes a neck extending from the base portion, the neck forming a narrower cross section relative to the base portion and corresponding to the second spine opening.

16. The blade assembly of any one or more clauses herein, the fastener including a wing extending from the neck, the wing forming a cross section greater than the neck.

17. The blade assembly of any one or more clauses herein, wherein the wing includes a ramp extending from the wing toward the base wall, wherein the ramp is configured to friction-fit the fastener to the spine when the fastener is positioned in the second spine opening.

18. The blade assembly of any one or more clauses herein, wherein the blade opening and retainer opening each extend co-directional to an extension of second spine opening from the first spine opening.

19. The blade assembly of any one or more clauses herein, the spine including a first face at which the first spine opening and the second spine opening are formed; and a second face extending over the fastener extended into the first spine opening or second spine opening, wherein the first face and the second face form a plenum therebetween at which at least a portion of the fastener extended through the first spine opening or second spine opening is positioned.

20. A tool assembly for assembling a blade assembly, the tool assembly including a base forming a channel extending co-directional to a blade component of the blade assembly, wherein a fastener opening is formed in the channel, the fastener opening including a floor configured to receive a fastener of the blade assembly, wherein the floor is positioned in the fastener opening to allow a neck of the fastener to extend through the fastener opening, wherein a depth of the fastener opening corresponds to an extension along a height of a base wall of the fastener; and a press fixture configured to position over the blade component at the channel of the base, wherein the press fixture is configured to engage a spine of the blade assembly to translate the fastener along a direction of the blade component.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A hedge trimmer, comprising:
a housing configured at which a motor is disposed;
a blade assembly extending from the housing, the blade assembly comprising;
a blade component forming a blade opening through which a fastener is extendable;
a retainer forming a retainer opening through which the fastener is extendable;
a spine forming a first spine opening and a second spine opening, wherein the second spine opening extends from the first spine opening, and wherein the second spine opening forms a narrower cross section relative to the first spine opening, wherein the fastener is extendable into the second spine opening from the first spine opening, and wherein the retainer is positioned between the spine and the blade component.

2. The hedge trimmer of claim 1, wherein the fastener is friction-fit into the second spine opening.

3. The hedge trimmer of claim 1, the fastener comprising:
a base wall;
a tab extending from the base wall, wherein the tab comprises a base portion connected to the base wall, and wherein the tab comprises a neck extending from the base portion, the neck forming a narrower cross section relative to the base portion and corresponding to the second spine opening.

4. The hedge trimmer of claim 3, the fastener comprising:
a wing extending from the neck, the wing forming a cross section greater than the neck.

5. The hedge trimmer of claim 4, wherein the wing comprises a ramp extending from the wing toward the base wall, wherein the ramp is configured to friction-fit the fastener to the spine when the fastener is positioned in the second spine opening.

6. The hedge trimmer of claim 1, wherein the blade opening and retainer opening each extend co-directional to an extension of second spine opening from the first spine opening.

7. The hedge trimmer of claim 1, the spine comprising:
a first face at which the first spine opening and the second spine opening are formed; and
a second face extending over the fastener extended into the first spine opening or second spine opening, wherein the first face and the second face form a plenum therebetween at which at least a portion of the fastener extended through the first spine opening or second spine opening is positioned.

8. The hedge trimmer of claim 1, comprising:
a second fastener extendable through respective openings at the spine, the retainer, the blade component, and a blunt body member.

9. A blade assembly for a lawn and garden tool, the blade assembly comprising:
a blade component forming a blade opening through which a fastener is extendable;
a retainer forming a retainer opening through which the fastener is extendable;
a spine forming a first spine opening and a second spine opening, wherein the second spine opening extends from the first spine opening, and wherein the second spine opening forms a narrower cross section relative to the first spine opening, wherein the fastener is extendable into the second spine opening from the first spine opening, and wherein the retainer is positioned between the spine and the blade component.

10. The blade assembly of claim 9, wherein the fastener is friction-fit into the second spine opening.

11. The blade assembly of claim 9, the fastener comprising:
a base wall;
a tab extending from the base wall, wherein the tab comprises a base portion connected to the base wall, and wherein the tab comprises a neck extending from the base portion, the neck forming a narrower cross section relative to the base portion and corresponding to the second spine opening.

12. The blade assembly of claim 11, the fastener comprising:
a wing extending from the neck, the wing forming a cross section greater than the neck.

13. The blade assembly of claim 12, wherein the wing comprises a ramp extending from the wing toward the base wall, wherein the ramp is configured to friction-fit the fastener to the spine when the fastener is positioned in the second spine opening.

14. The blade assembly of claim 9, wherein the blade opening and retainer opening each extend co-directional to an extension of second spine opening from the first spine opening.

15. The blade assembly of claim 9, the spine comprising:
a first face at which the first spine opening and the second spine opening are formed; and
a second face extending over the fastener extended into the first spine opening or second spine opening, wherein the first face and the second face form a plenum therebetween at which at least a portion of the fastener extended through the first spine opening or second spine opening is positioned.

16. The blade assembly of claim 9, comprising:
a second fastener extendable through respective openings at the spine, the retainer, the blade component, and a blunt body member.

17. A tool assembly for assembling a blade assembly, the tool assembly comprising:
a base forming a channel extending co-directional to a blade component of the blade assembly, wherein a fastener opening is formed in the channel, the fastener opening comprising a floor configured to receive a fastener of the blade assembly, wherein the floor is positioned in the fastener opening to allow a neck of the fastener to extend through the fastener opening, wherein a depth of the fastener opening corresponds to an extension along a height of a base wall of the fastener; and
a press fixture configured to position over the blade component at the channel of the base, wherein the press fixture is configured to engage a spine of the blade assembly to translate the fastener along a direction of the blade component.

18. The tool assembly of claim 17, wherein the fastener comprises:
a base wall;
a tab extending from the base wall, wherein the tab comprises a base portion connected to the base wall, and wherein the tab comprises the neck extending from the base portion, the neck forming a narrower cross section relative to the base portion and corresponding to the second spine opening.

19. The tool assembly of claim 17, wherein the fastener comprises:
a wing extending from the neck, the wing forming a cross section greater than the neck, and wherein the wing comprises a ramp extending from the wing toward the base wall.

20. The tool assembly of claim 19, wherein the ramp is configured to friction-fit the fastener to the spine when the fastener is positioned in the second spine opening.
